(19) United States
(12) Patent Application Publication
(10) Pub. No.: US 2023/0215266 A1
(43) Pub. Date: Jul. 6, 2023

(54) TESTING OF PERIMETER DETECTION SYSTEMS

(71) Applicant: Stealth Technologies Pty Ltd, Subiaco, Western Australia (AU)

(72) Inventors: Elliot NICHOLLS, Subiaco, Western Australia (AU); Chao ZHANG, Subiaco, Western Australia (AU)

(73) Assignee: Stealth Technologies Pty Ltd, Subiaco, Western Australia (AU)

(21) Appl. No.: 18/011,177

(22) PCT Filed: Jun. 18, 2021
(86) PCT No.: PCT/AU2021/050640

§ 371 Date: Dec. 18, 2022

(30) Foreign Application Priority Data
Jun. 18, 2020 (AU) 2020902023

(51) Int. Cl. G08B 29/02; G08B 13/22

(52) U.S. Cl. CPC G08B 29/02; G08B 13/22

(57) ABSTRACT

A testing system of a perimeter intrusion detection system established in relation to a barrier comprises a mobile base; a member extendable from the mobile base towards a subject portion of the barrier; and a sensor for determining when the member contacts the barrier.

### FIELD OF THE INVENTION

The present invention relates to Perimeter Intrusion Detection Systems (PIDS) and testing thereof.

### BACKGROUND

Perimeter Intrusion Detection Systems (PIDS) are designed to detect attempts to intrude into a physical environment, usually delineated by a fence. There are many types of PIDS, for example: PhotoElectric (PE) beams, buried ElectroMagnetic (EM) cables, ultrasonic beams, accelerometers detecting movement of a fence, microwave curtains and microphonics (optic fibres). When a PIDS detects an intrusion, an alarm may be triggered.

To fully test that a PIDS is working usually requires physically testing its sensors by triggering the alarm. For example, for PE beams, the beam would be broken to determine that the overall system registers an alarm state.

At present these physical tests can be required to be performed at regular intervals, and in high security environments this could be several times every day. This involves a great deal of time from human resources and is also a very mundane repetitive job and is prone to human error/mistakes. Those performing the tests have even been known to damage sensors and equipment during testing as some PIDS may require striking the fence on which they are installed.

The present invention has been developed in this context.

Any references to documents that are made in this specification are not intended to be an admission that the information contained in those documents form part of the common general knowledge known to a person skilled in the field of the invention, unless explicitly stated as such.

### SUMMARY OF THE INVENTION

According to an aspect disclosed there is a testing system of a perimeter intrusion detection system established in relation to a barrier, said testing system comprising:

a mobile base;
a member extendable or extending from the mobile base towards a subject portion of the barrier;
a sensor for determining when the member contacts the barrier. Preferably, said sensor is independent of the perimeter intrusion detection system.

In an embodiment the member is in the form of an arm having an end that contacts the barrier.

In an embodiment the testing system comprises a transmitter for informing the perimeter intrusion detection system that testing is occurring or is about to occur. In an embodiment, when the sensor determined that the member contacts the barrier the transmitter informs the perimeter intrusion detection system that the testing system is conducting the testing. Advantageously, the perimeter intrusion detection system verifies that it detected the contact according to being informed that sensor determined that the contact occurred.

In an embodiment the mobile base is configured to approach the barrier so as to be positioned for testing the barrier. The mobile base could be remotely controlled, but preferably the mobile base is self-driving and more preferably comprises an autonomous and/or robotic vehicle.

In an embodiment the self-driving mobile base is configured to position itself at a testing position relative to the subject portion of the barrier. The testing position will be such that the subject portion is within reach of the arm. For example, within 0.5 m of the subject portion.

In an embodiment the subject portion is smaller than a length of the barrier. In an embodiment the subject portion is one of a number of portions of the barrier to be tested. In an embodiment the testing system comprises a receiver for receiving information designating the subject portion. In an alternative the self-driving base comprises a processor that determines the position of the subject portion.

In an embodiment the arm comprises an actuator for extending the arm from the mobile base. In an embodiment the arm is telescopically extendable. In an alternative or in addition the arm is articulated for extension.

In an embodiment the arm is configured to manipulate the fence on or after contact with the barrier, such as by tapping, pushing or jolting the fence, in a manner that should trigger the perimeter intrusion detection system. In an embodiment the actuator is configured to also manipulate the barrier. Alternatively, the arm comprises a manipulator configured to manipulate the barrier. In an embodiment the manipulator comprises a solenoid configured to move a barrier engaging part (such as a bumper) in a pattern. In an embodiment the pattern replicates actions for which the perimeter intrusion detection system is configured to detect, such as climbing or wire cutting. In an embodiment the pattern of movement replicates a plurality of forms of action for which the perimeter intrusion detection system is configured to detect. In an embodiment the pattern of movement replicates each form of action for which the perimeter intrusion detection system is configured to detect. For example, replicate climbing and then replicate wire cutting and then replicate lifting.

In an embodiment the sensor is a limit switch. Preferably the limit switch is arranged to activate when the barrier engaging part contacts the fence.

In an embodiment the transmitter is configured to inform the perimeter intrusion detection system of each form of action for which the perimeter intrusion detection system is configured to detect that is being tested by the testing system as it is occurring or is about to occur.

In an embodiment the self-driving mobile base comprises a navigation system for navigating the self-driving mobile base as it moves to/from the or each portion of the barrier to be tested.

In an embodiment the testing system comprises a receiver for receiving perimeter intrusion detection system detections. In an embodiment the received detections are compared to the tests performed. In an embodiment the testing system is configured to determine a threshold of manipulation (preferably by type of manipulation action) at which the perimeter intrusion detection system detects the testing of the barrier.

According to an aspect disclosed there is a testing system of a perimeter intrusion detection system established in relation to a perimeter, said testing system comprising:

a self-driving mobile base;
a sensor for determining when the mobile base is at a subject portion of the perimeter that is expected to trigger the perimeter intrusion detection system due to the presence of the mobile base at or near the subject portion of the perimeter, preferably said sensor is independent of the perimeter intrusion detection system;
a transmitter/receiver for one or both of informing the perimeter intrusion detection system that testing is occurring or is about to occur; and receiving perimeter intrusion detection system detections.

In this embodiment the subject portion of the perimeter may have a beam cross detection, or mass detection.

According to an aspect disclosed there is a method of testing of a perimeter intrusion detection system established in relation to a barrier, said method comprising:

positioning a mobile base in a testing position in relation to the barrier;
extending an arm from the mobile base towards a subject portion of the barrier;
determining when the arm contacts the barrier.

In an embodiment the step of determining when the arm contacts the barrier occurs independently of the perimeter intrusion detection system detecting a contact to the barrier. In an embodiment the method further comprises checking that the perimeter intrusion detection system detected the arm contacting the barrier when it was determined that the arm contacted the barrier.

In an embodiment the contact with the fence is of a type, or each type, which should be detected by the perimeter intrusion detection system.

According to an aspect disclosed there is a method of testing of a perimeter intrusion detection system established in relation to a perimeter, said method comprising:
positioning a self-driving mobile base in a testing position in relation to the perimeter; determining when the mobile base is at a subject portion of the perimeter that is expected to trigger the perimeter intrusion detection system due to the presence of the mobile base at or near the subject portion of the perimeter;
communicating with the perimeter intrusion detection system one or both of: informing the perimeter intrusion detection system that testing is occurring or is about to occur; and receiving perimeter intrusion detection system detections.

According to an aspect disclosed there is a testing system of a perimeter intrusion detection system established in relation to a barrier, said testing system comprising:

a member mounted to a base positioned at a subject portion of the barrier;
an actuator supported by the member, the actuator for manipulating the fence in a plurality of actions for triggering respective intrusion types to test the perimeter intrusion detection system.

In an embodiment the member comprises an actuator head that manipulates the barrier. In an embodiment the member is an extendable arm.

According to an aspect disclosed there is a method of testing of a perimeter intrusion detection system established in relation to a barrier, said method comprising: positioning a member at a subject portion of the barrier;

manipulating the subject portion of the fence with the member or portion thereof in one of more of a plurality of actions for triggering respective intrusion types to test the perimeter intrusion detection system;

determining whether the manipulation triggers an intrusion detection by the perimeter intrusion detection system.

In this specification the terms “comprising” or “comprises” are used inclusively and not exclusively or exhaustively.

### SUMMARY OF DRAWINGS

In order to provide a better understanding, embodiments of the present invention will be described, by way of example only, with reference to the accompanying drawings, in which:

FIG. 1 is a schematic plan view of a testing system performing a test of a permitter fence according to an embodiment of the present invention;

FIG. 2 is a schematic set of diagram elements showing a sequence of steps in the use of an arm of the testing system to perform a test according to an embodiment of the present invention;

FIG. 3 is a side elevation of the arm of FIG. 2;

FIG. 4 is a side view of a manipulator of the arm of FIG. 3;

FIG. 5 is a front view of the manipulator of the arm of FIG. 3;

FIG. 6 is a top view of the manipulator of the arm of FIG. 3;

FIG. 7 is a flow chart of a method of testing according to an embodiment of the present invention;

FIG. 8 is a flow chart of a method of control of the test system according to an embodiment of the present invention; and

FIG. 9 is a schematic block diagram of a testing system performing a test of a permitter area and a perimeter fence according to an embodiment of the present invention.

### DETAILS DESCRIPTION OF EMBODIMENTS

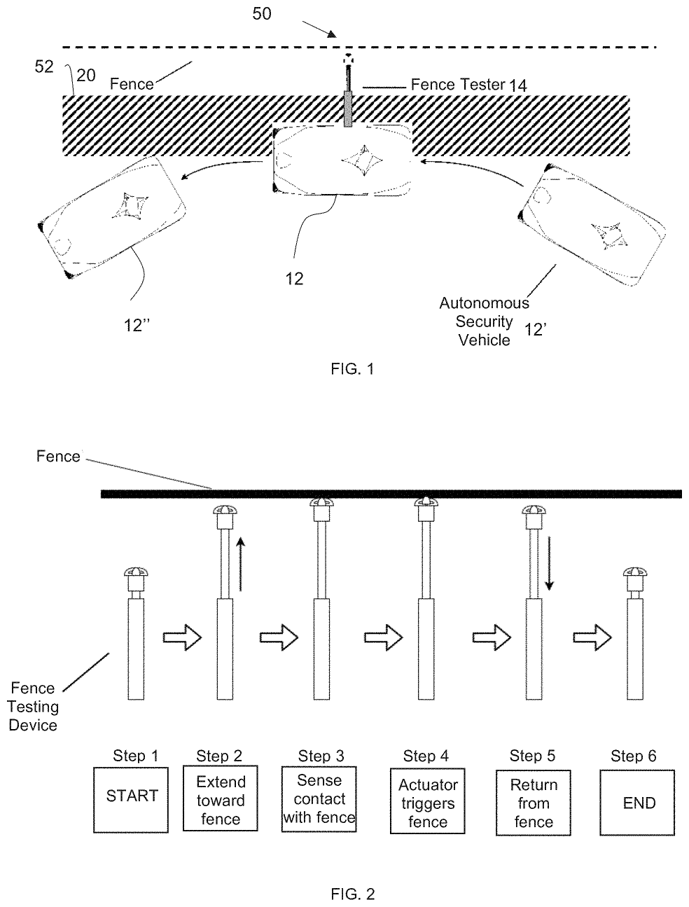

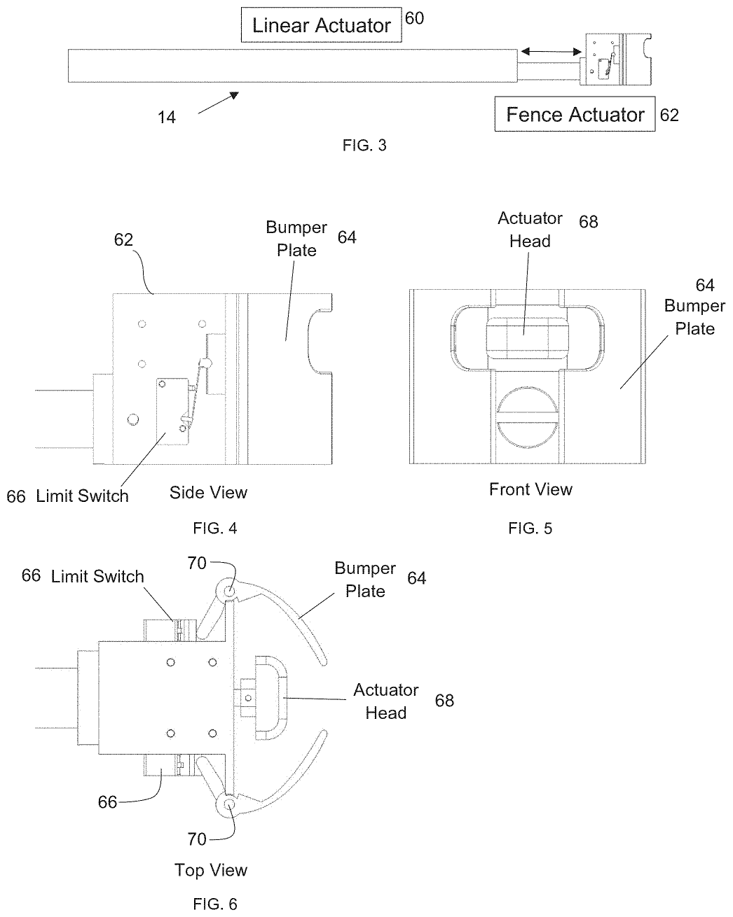

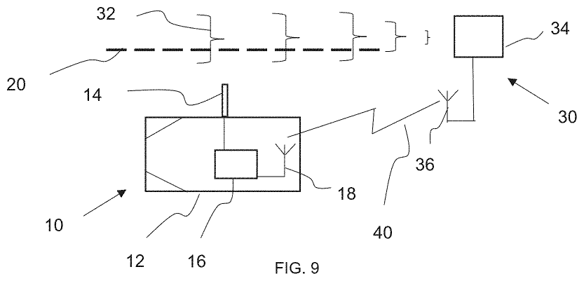

Referring to FIGS. 1, 2 and 9, there is a testing system 10 usable for testing a perimeter intrusion detection system 30 established in relation to a barrier, preferably a fence 20 or another form of barrier, such as a wall. The testing system 10 comprises base that may be fixed in position, but is preferably mobile and more preferably is a self-driving mobile base 12, in the form of an autonomous/robotic vehicle configured to position itself (from an approach position 12′) at a testing position relative to a subject portion 50 of the fence 20 (then departs through a departure position 12″). The testing position will be such that the subject portion 50 is within reach of an arm 14. For example, within 50 cm of the subject portion 50. In the fixed base embodiment, the base may be positioned on the ground near the fence and the arm may have a reach that enables the fence to be tested at a plurality of subject portions. In a mobile base embodiment, that is not self-driving, the base may be deployed in the testing position or may be remote controlled to move to the test position.

The perimeter intrusion detection system 30 will have one or more sensors to detect instruction on the perimeter. There are numerous known sensor types including those that use beams 32 or detect vibrations, such as PhotoElectric (PE) beams, buried ElectroMagnetic (EM) cables 52, ultrasonic beams, accelerometers detecting movement of a fence, microwave curtains, microphones and optic fibres. These sensors typically are able to discriminate against many false alarms by filtering out known false alarm causes, such as high wind. The system 30 has or is connected to or is part of a management system 34 that monitors the sensor(s) and generates and alarm when an intrusion is detected. The management system 34 typically has a testing mode that notes an instruction but does not raise a full alarm so that the detection system can be tested. Typically, testing is desired to occur frequently, sometimes a number of times a day, in high security environments such as military installations or prisons (correction facilities).

The mobile base 12 supports the arm 14 and which is extendable from the mobile base 12 towards the subject portion of the fence 20. The arm 14 comprises an actuator, such as a ram, for extending the arm from the mobile base 12. In this embodiment the arm 14 has a sleeve portion 60 which is telescopically extendable although it could take other forms, such as being articulated for extension.

The arm 14 also comprises an actuator portion 62 comprising a sensor, such as a switch 66, for determining when the arm 14, and in particular a fence engaging part (such as a bumper 64 seen in FIGS. 4 to 6) contacts the fence. The contact switch 66 is arranged to activate when the fence engaging part 64 contacts the fence 20. The switch 66 is not part of the PID 30, instead being part of the testing system 10. In this embodiment there are two bumper plates 64 pivotally attached (at pivot point 70) to an end of the arm and which when pivoted by contact with the fence each actuates a respective switch 66. The activation of one or both of the switches 66 functions to limit the extension of the arm 14 further towards the fence 20. This may also provide feedback on the angle of contact with the fence.

In an embodiment the arm 14 is configured to manipulate the fence 20 on or after contact with the fence 20, such as by tapping, pushing or jolting the fence, in a manner that should trigger the perimeter intrusion detection system. In an embodiment the actuator is configured to also manipulate the fence 20, such as with an actuator head seen in FIGS. 5 and 6. Alternatively, the arm comprises a manipulator configured to manipulate the fence. In an embodiment the manipulator comprises a solenoid configured to move the fence engaging part (such as the bumper) or the head 68, as shown, in a pattern. In an embodiment the pattern replicates actions for which the perimeter intrusion detection system is configured to detect, such as climbing or wire cutting. In an embodiment the pattern of movement replicating a plurality of forms of action for which the perimeter intrusion detection system is configured to detect. In an embodiment the pattern of movement replicating each form of action for which the perimeter intrusion detection system is configured to detect.

In an embodiment the testing system 10 comprises a processor 16 and a transmitter/receiver 18 for informing a transmitter/receiver 36 of the perimeter intrusion detection system 30 that testing is occurring or is about to occur. In an embodiment the processor is a mission control computer of the self-driving mobile base 12. The processor 16 also received a signal from the sensor switch 66.

In an embodiment the transmitter/receiver 18 is configured to inform the perimeter intrusion detection system 30 of each form of action for which the perimeter intrusion detection system 30 is configured to detect that is being tested by the arm 14 as it is occurring or is about to occur.

In an embodiment the subject portion 50 is smaller than a length of the fence 20. In an embodiment the subject portion 50 is one of a number of portions of the fence 20 to be tested. In an embodiment the testing system 10 comprises a receiver for receiving information designating the subject portion 50. In an alternative the processor 16 is configured to determine the position of the fence that is the subject portion, such as by an algorithm or randomly. Preferably the processor 16 is configured with a guidance or navigation system for navigating the self-driving mobile base 12 as it moves to/from the or each portion of the fence to be tested as indicated in FIG. 1.

In an embodiment the transmitter/receiver 18 is for receiving perimeter intrusion detection system 30 detections. In an embodiment the received detections are compared to the tests performed. In an embodiment the testing system 10 is configured to determine a threshold of manipulation (preferably by type of manipulation action) at which the perimeter intrusion detection system 30 detects the testing of the fence 20. The detections can be stored and compared to historic records. This can be useful for maintenance/failure prediction.

As an alternative, or in addition to the extension of the arm 14, the presence of the mobile base 20 over or near a detection position 52 (such as from the mass of the mobile base in proximity to a buried EM cable, breaking a beam, such as a PE beam, etc.) will be detected by the perimeter intrusion detection system 30 and communication with the perimeter intrusion detection system 30 establishes whether the test is successful or not. The communication may be transmission/receipt for one or both of: informing the perimeter intrusion detection system that testing is occurring or is about to occur; and receiving perimeter intrusion detection system detections.

The perimeter intrusion detection system may integrate with or be part of a facility management system, such as the Honeywell managed facilities system called Enterprise Buildings Integrator (EBI). The communication can be configured as required and can include notification in either or both directions. For example, the Honeywell EBI building management software can be notified by the testing system before testing at a point, and the testing system can be notified by the building management software that a portion of the perimeter/fence is in a maintenance/testing mode.

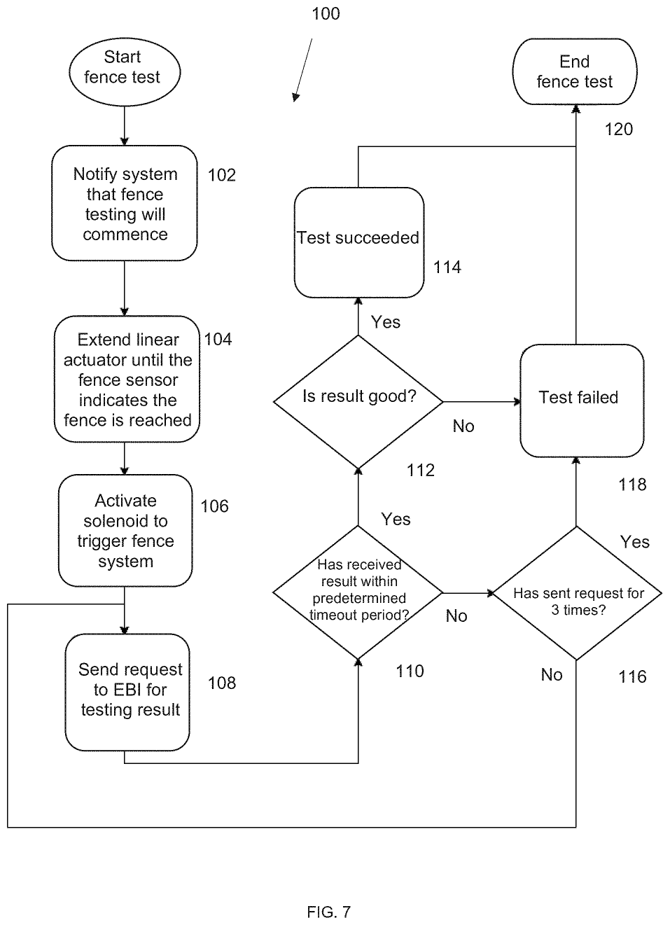

A method 100 of testing is shown in FIG. 7. When started, at the testing position, the test system sends the EBI or other PIDS a notification that testing will commence to enter test mode before the test is started, at 102. The arm 14 is extended at 104 until the sensor detects contact with the fence 20. The solenoid of the actuator head 48 is activated to trigger the fence system 30, at 106. The system 10 communicates with the EBI to request the test result at 108. The system 10 waits for the result at 110. If received, the system 10 then checks whether the result of the test is correct at 112. If it is as expected, then the test is successful 144 and the mission then proceeds at 120. If at 110 the result is not returned in time, then if the number of tries is not exceeded at 116, the request at 108 is repeated. However, if the number of tries is too many (eg. three times), or the result is not as expected at 112, then the test is recorded as a failure at 118 and then system continues with its mission at 120.

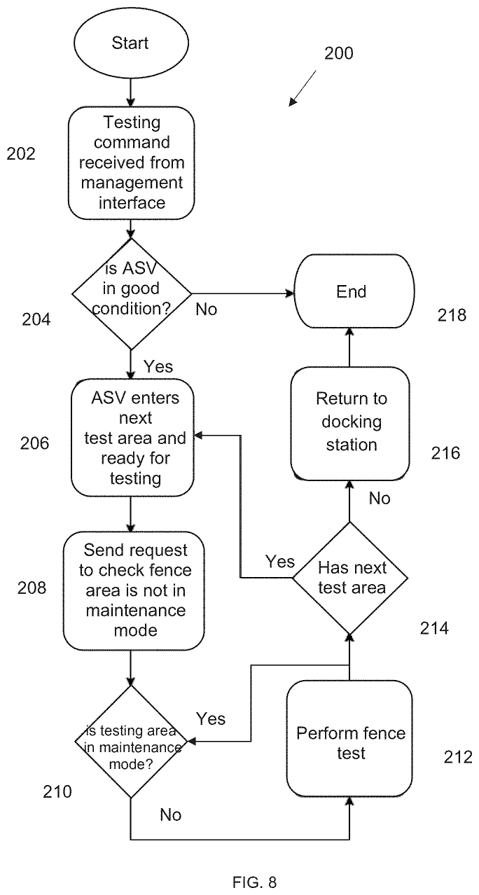

A method 200 of control of the test system 10 is shown in FIG. 8. When started, the self-driving mobile base 12 may be at a different location. A test command is received from the PIDS, or EBI or as a self determined mission requirement, at 202. The system 10 may perform a diagnostic to determine that it is in good condition (for example that it has sufficient battery charge) at 204. If it is not, then it aborts the test mission at 218. If in a good condition at 206, the system moves to and enters the test area. Then it requests the PIDS/EBI to determine if that portion of the fence is in maintenance mode 208 before starting testing at a location. The PIDS/EDI may be in maintenance/test mode 208 or instead a request to enter maintenance/test mode (instead of normal alarm mode), or it may be told when it may proceed with a test. When at 210 it is ready to perform the test. It does so at 212, as described above. If not ready or once the test is performed, it checks whether it has another mission to go to, and then goes to the next area at 214. If so, it progresses back to 206. If no more testing is required, it returns at 216 to its docking station and then control process ends at 218, with the mission completed.

The arm may be adapted to test energised toppings (electrified fence) as these are also common PIDs.

The present invention does not require humans to be involved in the testing of PIDS and the associated problem of humans testing differently each time, making mistakes and breaking expensive equipment. The self-driving aspect of embodiments of the invention is fully automatic and needs no human involvement. It can perform PIDS testing at any number of required locations by moving itself between test locations in a repeatable, reliable manner in all weather including at night time. It is also able to interrogate the PIDS system to determine that an alarm has been triggered at each point as it proceeds and can report during or at the end of the mission the results of the testing. The manipulation aspect of the invention is able to replicate different types of manipulation for testing different types of PIDSs.

Modifications may be made to the present invention within the context of that described and shown in the drawings. Such modifications are intended to form part of the invention described in this specification.

1-26. (canceled)

27. A testing system of a perimeter intrusion detection system established in relation to a barrier, said testing system comprising:
a mobile base;
a member extendable from the mobile base towards a subject portion of the barrier;
a sensor independent of the perimeter intrusion detection system for determining when the member contacts the barrier.

28. A system according to claim 27, wherein said extendable member is supported above the ground by the mobile base independent of the barrier.

29. A system according to claim 27, wherein the member is in the form of an arm having an end that contacts the barrier when the arm is extended towards the subject portion and when the mobile base is adjacent the subject portion.

30. A system according to claim 29, wherein the testing system comprises a transmitter for transmitting a message to the perimeter intrusion detection system informing the perimeter intrusion detection system that testing is occurring or is about to occur.

31. A system according to claim 30, wherein when the sensor determined that the member contacts the barrier, the transmitter informs the perimeter intrusion detection system that the testing system is conducting the testing.

32. A system according to claim 27, wherein the mobile base is configured to approach the barrier so as to be positioned adjacent the subject portion for testing the perimeter intrusion detection system.

33. A system according to claim 27, wherein the mobile base is movable across the ground from or to a position adjacent the subject portion.

34. A system according to claim 27, wherein the testing system comprises a receiver for receiving information designating the subject portion.

35. A system according to claim 27, wherein the arm comprises an actuator for extending the arm from the mobile base.

36. A system according to claim 35, wherein the arm is telescopically extendable.

37. A system according to claim 35, wherein the arm is articulated for extension.

38. A system according to claim 27, wherein the arm is configured to manipulate the barrier on or after contact with the barrier in a manner that is expected to trigger the perimeter intrusion detection system.

39. A system according to claim 38, wherein the manipulation of the barrier is in a manner to test a plurality of different types of intrusion detection.

40. A system according claim 27, wherein the mobile base comprises a receiver for receiving perimeter intrusion detection system detections.

41. A system according to claim 40, wherein the received detections are compared to the tests performed.

42. A testing system of a perimeter intrusion detection system established in relation to a perimeter, said testing system comprising:
a self-driving mobile base;
a sensor independent of the perimeter intrusion detection system for determining when the mobile base is at a subject portion of the perimeter that is expected to trigger the perimeter intrusion detection system due to the presence of the mobile base at or near the subject portion of the perimeter;
a transmitter/receiver for one or both of informing the perimeter intrusion detection system that testing is occurring or is about to occur; and receiving perimeter intrusion detection system detections.

43. A system according to claim 42, wherein said mobile base comprises a member extendable from the mobile base towards a subject portion of the barrier at the subject portion of the perimeter and a second sensor independent of the perimeter intrusion detection system for determining when the member contacts the barrier.

44. A system according to claim 42, wherein the subject portion of the perimeter has a beam cross detection, or mass detection, and when it has both, both are able to be tested.

45. A method of testing of a perimeter intrusion detection system established in relation to a barrier, said method comprising:
positioning a self-driving mobile base in a testing position in relation to the barrier;
extending an arm from the mobile base towards a subject portion of the barrier;
determining when the arm contacts the barrier independently of the perimeter intrusion detection system detecting a contact to the barrier.

46. A method according to claim 45, wherein the method further comprises checking that the perimeter intrusion detection system detected the arm contacting the barrier when it was determined that the arm contacted the barrier.

47. A method of testing of a perimeter intrusion detection system established in relation to a perimeter, said method comprising:
positioning a self-driving mobile base in a testing position in relation to the perimeter;
determining when the mobile base is at a subject portion of the perimeter that is expected to trigger the perimeter intrusion detection system due to the presence of the mobile base at or near the subject portion of the perimeter;
communicating with the perimeter intrusion detection system one or both of: informing the perimeter intrusion detection system that testing is occurring or is about to occur; and
receiving perimeter intrusion detection system detections.

48. A testing system of a perimeter intrusion detection system established in relation to a barrier, said testing system comprising:
a member mounted to a base positioned at a subject portion of the barrier;
an actuator for manipulating the fence in a plurality of actions for triggering respective intrusion types to test the perimeter intrusion detection system.

49. A system according to claim 48, wherein the member comprises an actuator head that manipulates the barrier.
